(19) United States
(12) Patent Application Publication
(10) Pub. No.: US 2026/0278620 A1
(43) Pub. Date: Sep. 17, 2026

(54) SYSTEM AND METHOD FOR DIGITAL QUALIFICATION VERIFICATION

(71) Applicant: Logistics and Supply Chain MultiTech R&D Centre Limited, Pok Fu Lam (HK)

(72) Inventors: Yi Jun He, Pok Fu Lam (HK); Tsz Ho Pun, Pok Fu Lam (HK); Chiu Lok Tang, Pok Fu Lam (HK); Chun Fai Chan, Pok Fu Lam (HK); Chung Dak Shum, Pok Fu Lam (HK)

(21) Appl. No.: 19/079,638

(22) Filed: Mar. 14, 2025

(51) Int. Cl. G06Q 30/018; H04L 9/40

(52) U.S. Cl. CPC G06Q 30/018; H04L 63/0428; H04L 63/0838

(57) ABSTRACT

A system and method for digital qualification verification. The system includes a qualification verification server including a processor and a non-transitory computer readable medium, the qualification verification server configured to communicate with one or more user devices, the non-transitory computer readable medium being operatively coupled to the processor, the non-transitory computer readable medium storing executable instructions, when executed by the processor causing the qualification verification server to: receive a verification request from an interested party to verify a qualification of a student, the verification request includes a shareable digital credential file from the student, wherein the shareable digital credential file is associated with the student, the shareable credential further file includes an authentication code, verify the qualification on a secure digital ledger, return a verification result to the interested party, the verification result includes a positive verification or an unverified result.

### FIELD OF THE INVENTION

The present invention relates to a system and method for digital qualification verification. In particular, the present invention relates to a system and method for digital qualification verification that employs a digital ledger.

### BACKGROUND OF THE INVENTION

Qualifications are generally issued by authorised entities such as for example universities, polytechnics, tertiary institutions and other educational institutions based on an approved qualification framework. Generally, governments or other central institutions define a qualification framework, and qualifications are issued under the defined framework.

One example of this is the Qualification Framework (QF) which was set up by the Hong Kong government (HKSAR) with the aim to provide a platform to facilitate and encourage lifelong learning. QF recognised qualifications are all quality assured and encompass qualifications in the academic, vocational, professional and continuing education sectors.

Qualifications recognised by a qualification framework e.g., QF recognition signifies credibility and quality of the qualification. Verification of qualifications submitted by applicants can be quite a time-consuming manual process. For example, for potential employers to verify the qualifications of applicants i.e., potential employees can be a time-consuming process for employers.

### SUMMARY OF THE INVENTION

The present invention relates to a system and method for digital qualification verification that employs a digital ledger. In one example, the present invention relates to a system and method for digital qualification verification that employs blockchain technology (i.e., a digital ledger). The system and method of the present invention ensures integrity, security, confidentiality, and availability of qualification information (i.e., qualification data) by employing a digital ledger technology such as blockchain technology. The present invention also relates to a method for uploading a recognised qualification to a secure digital ledger. The uploaded qualification can be verified by another interested party by employing the use of the digital ledger.

In accordance with a first aspect, there is provided a system for digital qualification verification comprising:
a qualification verification server comprising a processor and a non-transitory computer readable medium,
the qualification verification server configured to communicate with one or more user devices,
the non-transitory computer readable medium being operatively coupled to the processor, the non-transitory computer readable medium storing executable instructions, when executed by the processor causing the qualification verification server to:
   receive a verification request from an interested party to verify a qualification of a student,
   the verification request includes a shareable digital credential file from the student, wherein the shareable digital credential file is associated with the student, the shareable credential further file includes an authentication code,
   verify the qualification on a secure digital ledger,
   return a verification result to the interested party, the verification result includes a positive verification or an unverified result.

In one example the authentication code is a unique one-time authentication code that expires at the expiration date, and the one-time authentication code allowing the holder one time access to the digital ledger to verify the qualification of the student in the shareable digital credential file.

In one example the qualification verification server, as part of verifying the qualification, is configured to:
extract the shareable digital credential file, wherein the shareable digital credential file further comprising qualification information associated with the student,
check the secure digital ledger to match the qualification information within the shareable digital credential file and the qualification information stored in the secure digital ledger,
return a positive verification result if the qualification information in the secure digital ledger matches the qualification information in the shareable digital credential file.

In one example the qualification verification server comprises a verification portal that is presented to a user to allow a user to input the verification request to receive the verification request, and; the verification portal is configured to:
receive the verification request and verify the qualification,
verify the qualification on a secure digital ledger, and;
return a verification result to the interested party.

In one example the qualification verification wherein, the secure digital ledger is a blockchain that is configured to store a student's qualification information and personal information as hash data.

In one example the qualification verification server is configured to:
generate a digital credential file, wherein the digital credential file comprising qualification information and a unique qualification identifier, wherein the unique qualification identifier is associated with a student's qualification information,
provide the generated digital credential file to an educational institute that issued a qualification that is associated with the qualification information in the digital credential file,
storing the hash data into the secure digital ledger,
wherein the hash data is adapted to secure or obfuscate the student's personal data and the qualification information.

In one example the qualification and the credential file are not directly stored in the secure digital ledger.

In one example the qualification verification server is configured to:
transforming a student's personal information and qualification data into hash data,
storing the hash data in the secure digital ledger via a digital ledger API.

In one example the qualification verification server is configured to:
receive credential wallet associated with a student,
wherein the credential wallet includes a student's personal information, and a unique student identifier associated with the student,
register the credential wallet and data within the wallet on the secure digital ledger or storing the credential wallet and data within the wallet in the qualification verification server.

In one example the credential wallet associated with the student is configured to store the digital credential file.

In one example the qualification verification server is configured to:
receive individual qualification data from an institution, wherein the qualification corresponds to a student's qualification,
generate a hash,
convert the hash into a qualification identifier,
generate a digital credential file to be shared with an institution or a student, wherein the digital credential file includes the qualification identifier and qualification data,
transform the digital credential file into the hash data for storing in the secure digital ledger.

In one example the qualification server is configured to:
receive a request for a shareable digital credential file,
generate a shareable digital credential file,
send the shareable digital credential file to the student or store the shareable digital credential file into a student wallet for access,
wherein the shareable digital credential file includes qualification information, a unique authentication code.

In accordance with a second aspect, there is provided a computer implemented method for digital qualification verification comprising:
receiving a verification request from an interested party to verify a qualification of a student,
wherein the verification request includes a shareable digital credential file from the student, wherein the shareable digital credential file is associated with the student, the shareable credential further file includes an authentication code,
verifying the qualification on a secure digital ledger,
returning a verification result to the interested party, the verification result includes a positive verification or an unverified result.

In one example, the authentication code is a unique one-time authentication code that expires at the expiration date, and the one-time authentication code allowing the holder one time access to the digital ledger to verify the qualification of the student in the shareable digital credential file.

In one example the secure digital ledger is a blockchain storing qualification data and student personal information as hash data, wherein the step of verifying the qualification comprising the steps of:
extracting the shareable digital credential file, wherein the shareable digital credential file further comprising qualification information associated with the student,
checking the secure digital ledger to match the qualification information within the shareable digital credential file and the qualification information stored in the secure digital ledger, and;
returning a positive verification result if the qualification information in the secure digital ledger matches the qualification information in the shareable digital credential file.

In one example the method comprising:
receiving a credential wallet associated with a student,
wherein the credential wallet includes a student's personal information, and a unique student identifier associated with the student,
registering the credential wallet and data within the wallet on the secure digital ledger.

In one example the method comprising:
receiving a request for a shareable digital credential file,
generating a shareable digital credential file,
sending the shareable digital credential file to the student or store the shareable digital credential file into a student wallet for access, and;
wherein the shareable digital credential file includes qualification information, and a unique authentication code.

In accordance with a further aspect, there is provided a computer-implemented method for uploading a recognized qualification to a secure digital ledger comprising the steps of:
receiving individual qualification data from an institution, wherein the qualification corresponds to a student's qualification,
converting the hash into a qualification identifier,
generating a digital credential file to be shared with an institution or a student, wherein the digital credential file includes the qualification identifier and qualification data, and;
transforming the digital credential file into the hash data for storing in the secure digital ledger.

In one example the qualification data is received as a qualification file, the qualification file including qualification data expressed in a predefined template and the qualification file further including a qualification identifier.

In one example the method comprising the additional steps of:
extracting qualification data and hash,
verifying the qualification data,
generating a qualification identifier, wherein the qualification identifier is generated by converting the hash into an identifier,
returning the qualification identifier, and;
generating a digital credential file which includes the qualification identifier and qualification data.

In a further aspect, there is provided a data processing apparatus for digital qualification verification to verify a qualification of a person comprising a means or hardware element for carrying out the method for digital qualification verification to verify a qualification of a person as defined in any one of the steps above.

A computer program comprising instructions which, when the program is executed by a computer, cause the computer to carry out the method for digital qualification verification to verify a qualification of a person.

A computer-readable medium comprising instructions which, when executed by a computer, cause the computer to carry out the method for digital qualification verification to verify a qualification of a person.

The term “digital ledger” or “digital ledger technology” and (grammatical variations) as used herein are used in the inclusive sense to define a computerized record of transactions or other data (e.g., qualifications). A digital ledger is a database or digital record that stores and shares data across a network of participants. The digital ledger can utilize cryptography to secure data and the ledger is distributed across multiple participants such that the participants agree on the contents of the ledger. One example as described herein of a digital ledger is a blockchain or blockchain technology. The terms digital ledger and blockchain may be interchangeably used in this disclosure. The digital ledger may be a secure digital ledger.

The term “qualification” or “digital qualification” refers to a qualification issued by an authorized entity under an approved qualification framework.

The term “comprising” (and its grammatical variations) as used herein are used in the inclusive sense of “having” or “including” and not in the sense of “consisting only of”.

It is to be understood that, if any prior art information is referred to herein, such reference does not constitute an admission that the information forms a part of the common general knowledge in the art, in Australia or any other country

### BRIEF DESCRIPTION OF THE DRAWINGS

Embodiments of the present invention will now be described, by way of example, with reference to the accompanying drawings in which:

FIG. 1 illustrates a system for qualification verification and the components of the system.

FIG. 2 illustrates a schematic diagram of a qualification verification server.

FIG. 3 illustrates a method for digital qualification verification.

FIG. 4 illustrates an example method for uploading a recognized qualification to a secure digital ledger.

FIG. 5 a qualification verification process and the wallet and its functions.

### DETAILED DESCRIPTION OF ILLUSTRATIVE EMBODIMENTS

The present invention relates to a system and method for digital qualification sharing and verification that employs digital ledger technology such as for example blockchain technology.

The system according to the present invention provides a blockchain based platform for facilitating issuance and verification of a qualification e.g., a digital qualification (or digital credential). The users of the platform (i.e., system) can include institutes that issue qualifications to students, holders of qualifications e.g., students and parties such as employers and other institutes who have interests in verifying these qualifications. Integrity, security, confidentiality and availability of qualifications or digital credentials are ensured by using a digital ledger technology such as blockchain technology. The platform further includes additional functionality to support management and sharing of qualification details to other users of the platform.

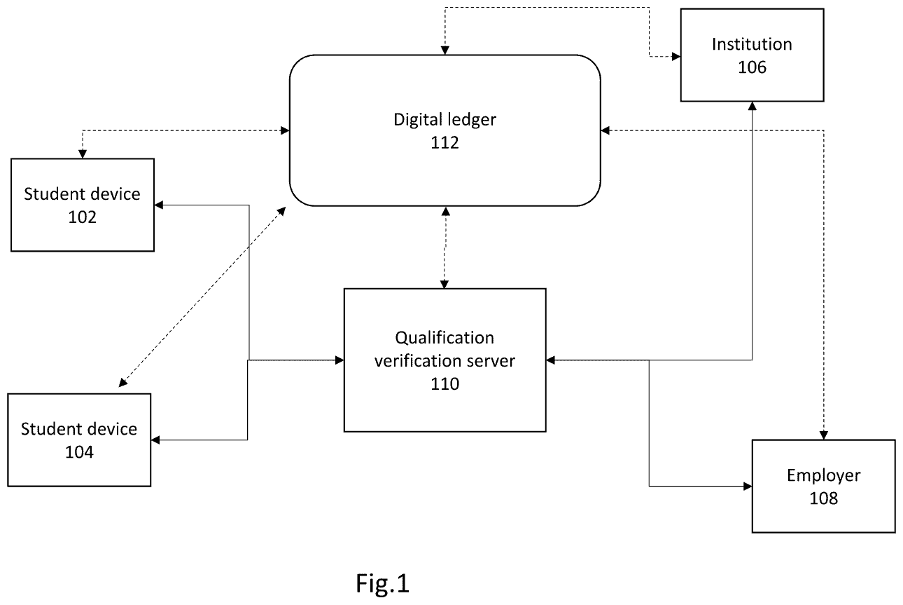

Referring to FIG. 1, an embodiment of a system 100 for digital qualification verification is illustrated. The system 100 can be used by an interested party to verify the qualification of another person. The verification is performed digitally by a computer implemented method for digital qualification verification. The system is adapted to access a secure digital ledger that stores qualification information to verify a person's qualifications.

Referring to FIG. 1 the system 100 for digital qualification verification to verify a qualification of a person comprising: a qualification verification server 110 comprising a processor 202 and a non-transitory computer readable medium 204, 206. The qualification verification server 110 is configured to communicate with one or more user devices. The user devices may include one or more student devices 102, 104 and a qualification institute 106. The server 110 may further be configured to communicate with one or more corporate user devices 108. The corporate users may be any parties interested in verifying a student's qualifications. For example, the corporate user may be an employer 108 that may be interested in hiring a student as an employee. Student devices may also cover employees or other people that have attained a qualification through an institute e.g., a university.

The non transitory computer readable medium being operatively coupled to the processor 202. The non transitory computer readable medium may be a memory unit or a memory device of the server 110. The non transitory computer readable medium 204, 206 storing executable instructions, when executed by the processor 202 causing the qualification verification server to: receive a verification request from an interested party (e.g., an employer 108) to verify a qualification of a student, wherein the verification request includes a shareable digital credential file from the student, wherein the shareable digital credential file is associated with the student, the shareable credential further file includes an authentication code, verify the qualification on a secure digital ledger 112, and; return a verification result to the interested party, the verification result include a positive verification or an unverified result.

In one example the authentication code is a unique one-time authentication code that expires at the expiration date. The one-time authentication code allowing the holder one time access to the digital ledger to verify the qualification of the student in the shareable digital credential file.

The digital ledger 112 is preferably a secure digital ledger that stores data in an encrypted form therein. The digital ledger may be a decentralized ledger. A copy of the ledger may be stored on multiple devices within a computing network. The digital ledger may be a public ledger or a private ledger. In one example, the digital ledger may be a blockchain. For example, the blockchain may be a public blockchain. In an alternative form the blockchain may be a private blockchain that may be accessible by approved users e.g., education institutions, students and approved employers or other approved parties. In the public blockchain any one can access information on the blockchain if they have an appropriate access code.

The student devices 102, 104, institution 106 and employer device can access or interact with the digital ledger 112 via the server 110. Optionally, the devices 102, 104, the institution device 106 and the employer device 108 may interact or access the digital ledger 112 directly. Each of the devices may include an application that is stored therein and executed by the device to enable the devices 102-108 to communicate with the server 110.

The verification server 110, as part of verifying the qualification, is configured to: extract the shareable digital credential file, wherein the shareable digital credential file further comprising qualification information associated with the student. The server 110 is further configured to check the secure digital ledger to match the qualification information within the shareable digital credential file and the qualification information stored in the secure digital ledger and return a positive verification result if the qualification information in the secure digital ledger matches the qualification information in the shareable digital credential file.

The system for digital qualification verification 100 for verifying a qualification of a person is advantageous because it provides a solution that ensure data confidentiality. The system meets the security requirements for multiple operators. The system 100, in particular the server 110 stores the hash value or uploads the hash value to the blockchain. The system 100 is also advantageous because it protects individual privacy. The system 100 is advantageous because it facilitates qualification verification. The blockchain used is immutable thereby ensuring accuracy of the qualification data stored therein and ensures people can't manipulate the stored qualifications.

In this example, the qualification server may be implemented as a computing apparatus. The computing apparatus (i.e., a computing device or computer) may be implemented by any computing architecture, including portable computers, tablet computers, stand-alone Personal Computers (PCs), smart devices, Internet of Things (IOT) devices, edge computing devices, client/server architecture, “dumb” terminal/mainframe architecture, cloud-computing based architecture, or any other appropriate architecture. The computing apparatus 110 may be appropriately programmed to implement the invention and facilitate qualification verification. The computing apparatus 110 may be programmed to execute a method of digital qualification verification 300.

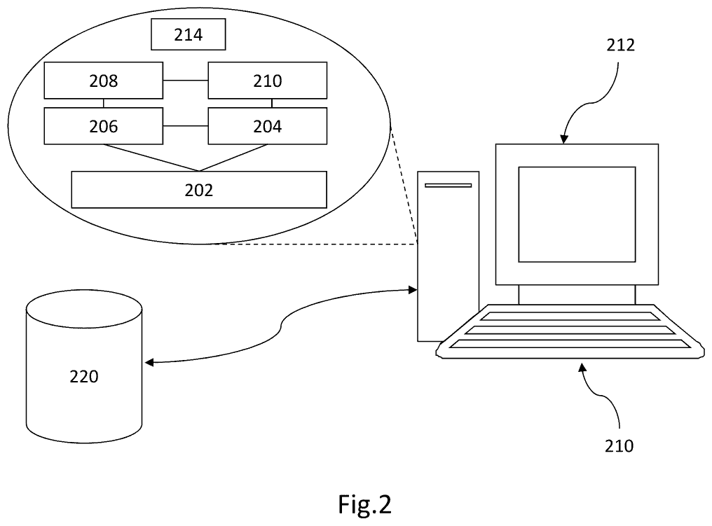

As shown in FIG. 2 there is a shown a schematic diagram of a qualification verification server 110 which is implemented as a computing apparatus 200. The server 110 may be arranged to be implemented as an example embodiment of a system for digital qualification verification. In the illustrated example the server 110 includes suitable components necessary to receive, store and execute appropriate computer instructions. The components may include a processor 202, including Central Processor (CPU), Math Co-Processor (Math Processor), Graphic Processor (GPUs) or Tensor processor (TPUs) for tensor or multi-dimensional array calculations or manipulation operations, read-only memory (ROM) 204, random access memory (RAM) 206, and input/output devices such as disk drives 208, input devices 210 such as an Ethernet port, a USB port, etc. Display 212 such as a liquid crystal display, a light emitting display, or any other suitable display may be provided. The display 212 may be an optional component. The server 110 may include instructions that may be included in ROM 204, RAM 206 or disk drives 208 and may be executed by the processor 202. There may be provided a plurality of communication links 214 which may variously connect to one or more computing devices such as a server, personal computers, terminals, wireless or handheld computing devices, Internet of Things (IoT) devices, smart devices, edge computing devices. At least one of a plurality of communications link may be connected to an external computing network through a telephone line or other type of communications link. The communication link 214 allows the server 110 to communicate with student devices, the institution and an employer via a communication network such as a cellular network or Wi-Fi or another network. The server 110 may include storage devices such as a disk drive 208 which may encompass solid state drives, hard disk drives, optical drives, magnetic tape drives or remote or cloud-based storage devices. The server 110 may use a single disk drive or multiple disk drives, or a remote storage service. The server 110 may also have a suitable operating system which resides on the disk drive or in the ROM of the server 110. The computing apparatus may further comprise one or more databases adapted to store one or more pieces of data.

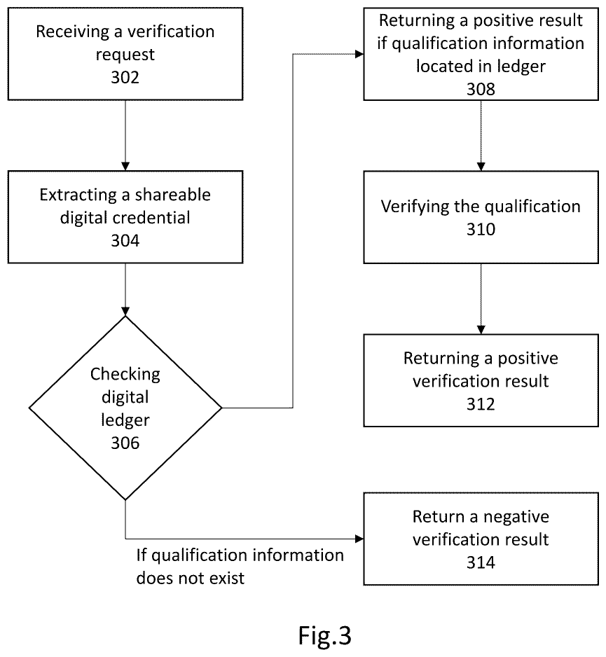

FIG. 3 illustrates a flow chart of an example computer implemented method for digital qualification verification 300. The method 300 may be executed by the qualification verification server 110. The method 300 may be embodied as computer readable and executable instructions that may be executed by the processor 202.

Method 300 starts at step 302. Step 302 comprises receiving a verification request from an interested party (e.g., an employer 108) to verify a qualification of a student. The verification request may include at least a shareable digital credential file from the student, wherein the shareable digital credential file is associated with the student, the shareable credential further file includes an authentication code. Step 304 comprises extracting the shareable digital credential file, wherein the shareable digital credential file further comprising qualification information associated with the student. Step 306 comprises checking the secure digital ledger to match the qualification information within the shareable digital credential file and the qualification information stored in the secure digital ledger 112. Step 308 comprises returning a positive verification result if the qualification information in the secure digital ledger matches the qualification information in the shareable digital credential file. Step 310 comprises verifying the qualification on a secure digital ledger if a positive verification is returned. Step 312 comprises return a positive verification result to the interested party, the verification result includes a positive verification or an unverified result. Step 306 is a conditional check if the qualification information exists in the ledger. Step 308 is executed the qualification information is located in the digital ledger.

If the qualification information does not exist at step 306, then step 314 is executed. Step 314 comprises providing a negative verification result. The negative verification result is indicative that the qualification information provided by the student cannot be verified.

The authentication code may be a unique one-time authentication code that expires at the expiration date, and the one-time authentication code allowing the holder one time access to the digital ledger to verify the qualification of the student in the shareable digital credential file.

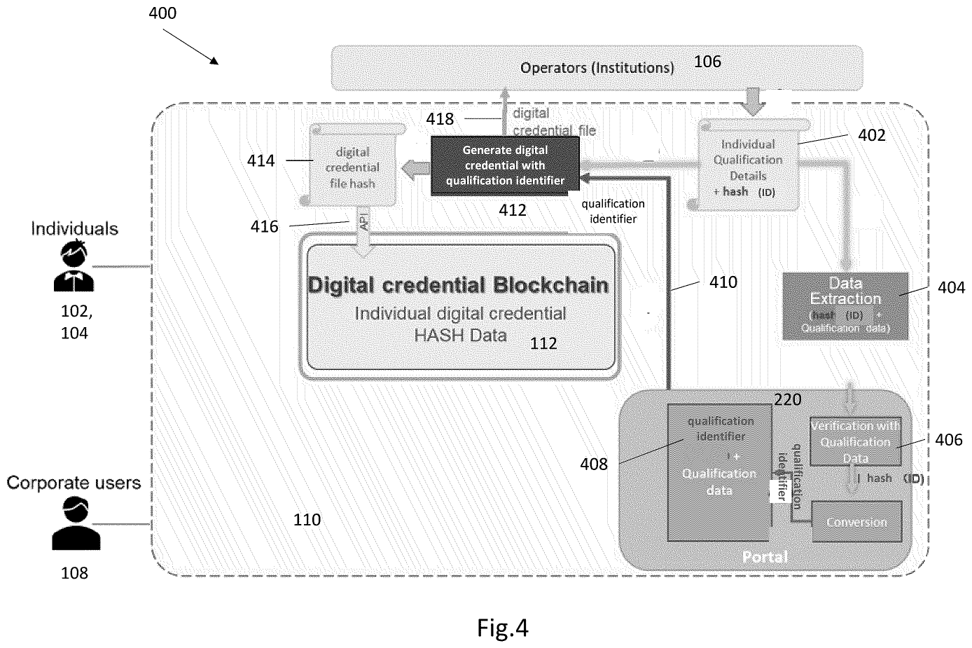

FIG. 4 illustrates an example method 400 method for uploading a recognized qualification to a secure digital ledger. The method 400 is a method of issuing a digital credential. FIG. 4 illustrates the procedure followed by an institution to upload a qualification framework recognized qualification to the digital ledger 112 e.g., a blockchain through an API provided to the institution device 106.

Referring to FIG. 4 step 402 comprises receiving individual qualification data 402 from an institution 106. The qualification data includes at least a student's qualification, such as qualification title, qualification level, year of entry, year of graduation, etc. A qualification file template is provided, indicating the accepted data format. Institutions generate a qualification data file following the template format. Then, the generated qualification data file is uploaded through a blockchain API. The API may be provided by the server 110. An institution can generate or offline transform institution ID or institution data into a hash. The qualification data and hash may be packaged as a file and the file may be uploaded to the server 110 through API.

The qualification data receives corresponds to a student's qualification. Step 404 comprises extracting qualification data and hash(ID). A portal 220 may be provided in the server 110. The portal 220 may be configured to extract the hash (ID), Qualification data from the data uploaded by institutions.

Step 406 comprises verifying the qualification data. Step 408 comprises generating a qualification identifier, wherein the qualification identifier is generated by converting the hash into an identifier. Step 410 comprises returning the qualification identifier. Step 412 comprises generating a digital credential file to be shared with an institution or a student. The digital credential file includes the qualification identifier and qualification data. Step 414 comprises transforming the digital credential file into hash data for storing in the secure digital ledger. At step 414 students' personal information, and qualification information are transformed into hash data. Step 416 comprises uploading the hash data to the secure digital ledger i.e., the blockchain. The data may be loaded to the blockchain 112 via an API. Step 418 comprises returning the generated digital credential to the institution. The hash data is adapted to secure or obfuscate the student's personal data and the qualification information.

In one example the qualification and the credential file are not directly stored in the secure digital ledger 112. Only the hash data and/or digital credential files are stored in the digital ledger 112.

In one example the qualification data is received as a qualification file, the qualification file including qualification data expressed in a predefined template and the qualification file further including a hash generated by an institution. The method 400 may be performed by the server 110.

Individuals can share their qualification(s) details in a secure, timely and customized manner, while employers and organizations can validate qualifications in an easy, efficient and trusted way. In order to achieve this a digital credential wallet for individuals is used. Individuals can store their digital credential file in an encrypted form, manage qualifications portfolio in wallet, and request for new sharable digital credential files. Additionally, an authentication protocol is used to authenticate credentials, and a one-time authentication code generated in this protocol can prevent fake qualification and restrict the number of times the employers can authenticate digital credentials. The system 100 provides an instant verification channel between wallets and blockchain and facilitates digital credential management.

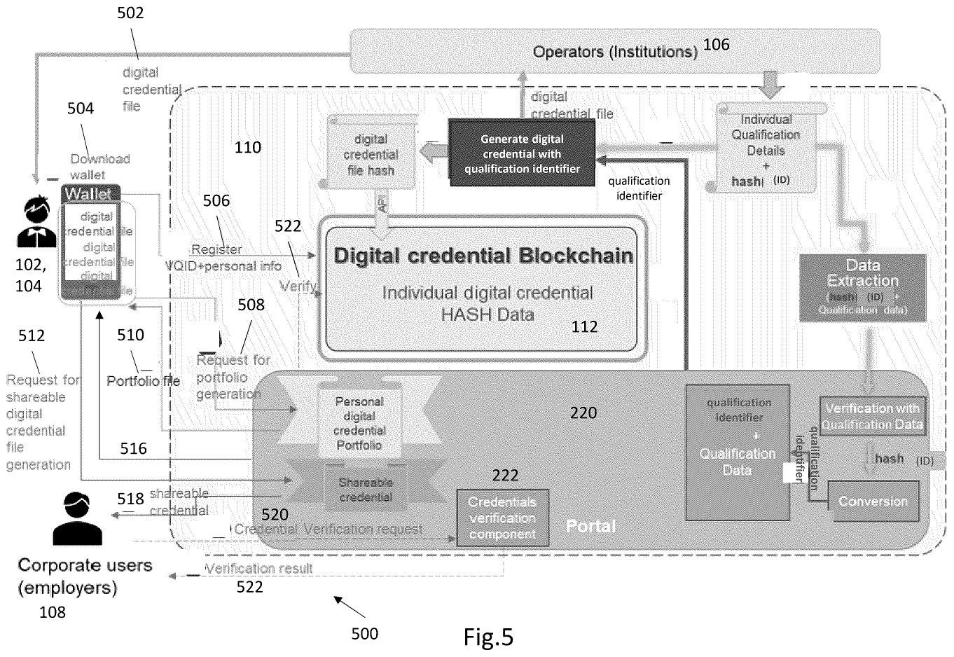

FIG. 5 illustrates a qualification verification process. FIG. 5 also illustrates the wallet and its functions. Referring to FIG. 5 step 502 the institution 106 can send the digital credential file to the student 102, 104. Step 504 the student can download a credential wallet. In one example, the digital wallet may be downloaded from the qualification verification server 110. In another example, the digital wallet may be downloaded from the digital ledger.

Step 506 comprises receiving a credential wallet associated with a student at the server 110. The student as part of step 506 may register the digital wallet in the digital ledger 112 via the server 110. The credential wallet includes a student's personal information, and a unique student identifier associated with the student. Step 508 comprises a student can request a personal digital credential portfolio from the portal 220. Step 510 comprises returning a portfolio file to a student wallet. The portfolio file may comprise a student's personal information, unique student identifier and optionally a digital credential file. A student can store a digital credential file associated with the student in the wallet. Steps 502 to 510 may be indicative of the digital wallet and its functions.

Step 512 comprises receiving a request for a shareable digital credential file. The server can receive the request and process the request. Step 514 comprises generating shareable digital credential file. Step 516 comprises sending the shareable digital credential file to the student. Alternatively at step 516 the digital credential may be stored in the student's wallet for access. The shareable digital credential file includes qualification information, a unique authentication code.

The shareable digital credential file may be shared by a student to an employer 108 at step 518. The employer 108 is one that wants to verify a student's (or potential employee's) qualifications. The server 110 may comprise a verification portal 222 (or a credential verification component). Step 520 comprises receiving a verification request to verify the qualification. Step 522 comprises verifying the qualification on a secure digital ledger i.e., by checking in the blockchain. The verification request may expire at the end of an expiration date or expiration time. Step 524 comprises returning a verification result to the employer 108. Steps 518 to 524 are indicative of an authentication process.

Step 522 may comprise the following additional steps to verify qualifications by checking the blockchain 112. Step 522 comprises the step of comprises extracting the shareable digital credential file, wherein the shareable digital credential file further comprising qualification information associated with the student. The server 110 is configured to check the secure digital ledger 112 to match the qualification information within the shareable digital credential file and the qualification information stored in the secure digital ledger 112. The server 110 is configured to return a positive verification result if the qualification information in the secure digital ledger matches the qualification information in the shareable digital credential file. If the qualification information cannot be matched, then a negative verification or an error may be returned.

Confidentiality, integrity and availability is considered as the core underpinning of information security. A key advantage of using a blockchain (i.e., digital ledger 112) is the key property of immutability. This means data stored on blockchain cannot be modified. Thus, integrity is preserved. The blockchain is a distributed ledger which can provide availability and avoid single point of failure. This is advantageous because the qualification data stored in the blockchain 112 cannot be manipulated resulting a high trust output.

The wallet provides encryption option to secure an individual's qualification data into a file in the wallet. The confidentiality of wallet is protected. The Blockchain never stores individual qualification data and personal data in plain text, so the confidentiality of blockchain is protected.

In addition, communication on blockchain is through HTTPS, which will encrypt all the communication to prevent eavesdroppers. Further, the blockchain is a permissioned blockchain. Anyone who wants to be a participant in the blockchain, needs to get approval from other nodes. Thus, this approval process prevents unauthorized users. Through wallets, students can verify their qualification records, manage their qualification portfolio, request to regenerate one or multiple shareable digital credentials to be verified by employers/organizations. This provides a simple and secure tool for students or employees to verify and manage their qualification data.

A qualification web portal 222 may be built. Employers/organizations can verify applicants' qualification through web portal. Additional APIs for institutions are provided to allows institutions to generate digital credentials.

The system 100 is advantageous because the system stores the hash value of the credential file instead of storing the credential file itself. Further the system is advantageous because the real individual identity is not stored in the blockchain 112, but instead a unique identifier is used to identify the student or other individual. The system 100 is also advantageous because the system provides an improved authentication and data sharing protocol. By using the system 100, individuals can share their qualification(s) details in a secure, timely and customized manner, while operators and corporate users can verify qualifications under the restrictions set by individuals, such as setting the verification expire date and view times. The system 100 also provides an additional layer of security since one time authentication codes are used to prevent fake qualifications.

The system 100 and method for digital qualification verification provides an improve way to allow interested parties to verify an individual's qualifications The system 100 also allows a student to store an authorised qualification in a secure manner such that the qualification data cannot be manipulated on the blockchain. The system for qualification verification is advantageous because it facilitates qualification verification by students and companies (employers), prevents fake qualifications, enables students to manage qualification portfolio and enhance privacy protection of students.

Although not required, the embodiments described with reference to the Figures can be implemented as an application programming interface (API) or as a series of libraries for use by a developer or can be included within another software application, such as a terminal or personal computer operating system or a portable computing device operating system. Generally, as program modules include routines, programs, objects, components and data files assisting in the performance of particular functions, the skilled person will understand that the functionality of the software application may be distributed across a number of routines, objects or components to achieve the same functionality desired herein.

It will also be appreciated that where the methods and systems of the present invention are either wholly implemented by computing system or partly implemented by computing systems then any appropriate computing system architecture may be utilised. This will include stand alone computers, network computers and dedicated hardware devices. Where the terms “computing system” and “computing device” are used, these terms are intended to cover any appropriate arrangement of computer hardware capable of implementing the function described.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

The phrases ‘computer-readable medium’ or ‘machine-readable medium’ as used in this specification and claims should be taken to include, unless the context suggests otherwise, a single medium or multiple media. Examples of multiple media include a centralised or distributed database and/or associated caches. These multiple media store the one or more sets of computer executable instructions. The phrases ‘computer-readable medium’ or ‘machine-readable medium’ should also be taken to include any medium that is capable of storing, encoding or carrying a set of instructions for execution by a processor of a computing device and that cause the processor to perform any one or more of the methods described herein. The computer-readable medium is also capable of storing, encoding or carrying data structures used by or associated with these sets of instructions. The ‘computer-readable medium’ or ‘machine-readable medium’ may be non-transitory.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc., in a computer program. When a process corresponds to a function, its termination corresponds to a return of the function to the calling function or a main function.

Aspects of the systems and methods described above may be operable or implemented on any type of specific-purpose or special computer, or any machine or computer or server or electronic device with a microprocessor, processor, microcontroller, programmable controller, or the like, or a cloud-based platform or other network of processors and/or servers, whether local or remote, or any combination of such devices.

Furthermore, embodiments may be implemented by hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

In the above description, a storage medium may represent one or more devices for storing data, including read-only memory (ROM), random access memory (RAM), magnetic disk storage mediums, optical storage mediums, flash memory devices and/or other machine or computer readable mediums for storing information.

The methods or algorithms described in connection with the examples disclosed herein may be embodied directly in hardware, in a software module executable by a processor, or in a combination of both, in the form of processor, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

One or more of the components and functions illustrated the figures may be rearranged and/or combined into a single component or embodied in several components without departing from the scope of the invention. Additional elements or components may also be added without departing from the scope of the invention. Additionally, the features described herein may be implemented in software, hardware, as a business method, and/or combination thereof.

In its various aspects, embodiments of the invention can be embodied in a computer-implemented process, a machine (such as an electronic device, or a general-purpose computer or other device that provides a platform on which computer programs can be executed), processes performed by these machines, or an article of manufacture.

1. A system for digital qualification verification comprising:
a qualification verification server comprising a processor and a non-transitory computer readable medium,
the qualification verification server configured to communicate with one or more user devices,
the non-transitory computer readable medium being operatively coupled to the processor, the non-transitory computer readable medium storing executable instructions, when executed by the processor causing the qualification verification server to:
receive a verification request from an interested party to verify a qualification of a student,
the verification request includes a shareable digital credential file from the student, wherein the shareable digital credential file is associated with the student, the shareable credential further file includes an authentication code,
verify the qualification on a secure digital ledger,
return a verification result to the interested party, the verification result includes a positive verification or an unverified result.

2. The system of claim 1, the authentication code is a unique one-time authentication code that expires at an expiration date, and the one-time authentication code allowing the holder one time access to the digital ledger to verify the qualification of the student in the shareable digital credential file.

3. The system of claim 1, wherein the qualification verification server, as part of verifying the qualification, is configured to:
extract the shareable digital credential file, wherein the shareable digital credential file further comprising qualification information associated with the student,
check the secure digital ledger to match the qualification information within the shareable digital credential file and the qualification information stored in the secure digital ledger,
return a positive verification result if the qualification information in the secure digital ledger matches the qualification information in the shareable digital credential file.

4. The system of claim 3, wherein the qualification verification server comprises a verification portal that is presented to a user to allow a user to input the verification request to receive the verification request, and; the verification portal is configured to:
receive the verification request and verify the qualification,
verify the qualification on a secure digital ledger, and;
return a verification result to the interested party.

5. The system of claim 3, wherein the qualification verification wherein the secure digital ledger is a blockchain that is configured to store a student's qualification information and personal information as hash data.

6. The system of claim 5, wherein the qualification verification server is configured to:
generate a digital credential file, wherein the digital credential file comprising qualification information and a unique qualification identifier, wherein the unique qualification identifier is associated with a student's qualification information,
provide the generated digital credential file to an educational institute that issued a qualification that is associated with the qualification information in the digital credential file,
storing the hash data into the secure digital ledger, and;
wherein the hash data is adapted to secure or obfuscate the student's personal data and the qualification information.

7. The system of claim 6, wherein the qualification and the credential file are not directly stored in the secure digital ledger.

8. The system of claim 6, wherein the qualification verification server is configured to:
transforming a student's personal information and qualification data into hash data, and;
storing the hash data in the secure digital ledger via a digital ledger API.

9. The system of claim 6, wherein the qualification verification server is configured to:
receive credential wallet associated with a student,
wherein the credential wallet includes a student's personal information, and a unique student identifier associated with the student, and;
register the credential wallet and data within the wallet on the secure digital ledger or storing the credential wallet and data within the wallet in the qualification verification server.

10. The system of claim 9, wherein the credential wallet associated with the student is configured to store the digital credential file.

11. The system of claim 6, wherein the qualification verification server is configured to:
receive individual qualification data from an institution, wherein the qualification corresponds to a student's qualification,
convert the hash data into a qualification identifier,
generate a digital credential file to be shared with an institution or a student, wherein the digital credential file includes the qualification identifier and qualification data, and;
transform the digital credential file into the hash data for storing in the secure digital ledger.

12. The system of claim 11, wherein the qualification server is configured to:
receive a request for a shareable digital credential file,
generate a shareable digital credential file,
send the shareable digital credential file to the student or store the shareable digital credential file into a student wallet for access, and;
wherein the shareable digital credential file includes qualification information, a unique authentication code.

13. A computer implemented method for digital qualification verification comprising:
receiving a verification request from an interested party to verify a qualification of a student,
wherein the verification request includes a shareable digital credential file from the student, wherein the shareable digital credential file is associated with the student, the shareable credential further file includes an authentication code,
verifying the qualification on a secure digital ledger, and;
returning a verification result to the interested party, the verification result includes a positive verification or an unverified result.

14. The method of claim 13, wherein the authentication code is a unique one-time authentication code that expires at an expiration date, and the one-time authentication code allowing the holder one time access to the digital ledger to verify the qualification of the student in the shareable digital credential file.

15. The method of claim 13, wherein the secure digital ledger is a blockchain storing qualification data and student personal information as hash data, wherein the step of verifying the qualification comprising the steps of:
extracting the shareable digital credential file, wherein the shareable digital credential file further comprising qualification information associated with the student,
checking the secure digital ledger to match the qualification information within the shareable digital credential file and the qualification information stored in the secure digital ledger, and;
returning a positive verification result if the qualification information in the secure digital ledger matches the qualification information in the shareable digital credential file.

16. The method of claim 15, comprising:
receiving a credential wallet associated with a student,
wherein the credential wallet includes a student's personal information, and a unique student identifier associated with the student, and;
registering the credential wallet and data within the wallet on the secure digital ledger.

17. The method of claim 15, comprising:
receiving a request for a shareable digital credential file,
generating a shareable digital credential file,
sending the shareable digital credential file to the student or store the shareable digital credential file into a student wallet for access, and;
wherein the shareable digital credential file includes qualification information, a unique authentication code.

18. A computer-implemented method for uploading a recognized qualification to a secure digital ledger comprising the steps of:
receiving individual qualification data from an institution, wherein the qualification corresponds to a student's qualification,
converting hash data into a qualification identifier,
generating a digital credential file to be shared with an institution or a student, wherein the digital credential file includes the qualification identifier and qualification data, and;
transforming the digital credential file into the hash data for storing in the secure digital ledger.

19. The method of claim 18, wherein the qualification data is received as a qualification file, the qualification file including qualification data expressed in a predefined template and the qualification file further including a hash generated by an institution.

20. The method of claim 18, comprising the additional steps of:
extracting qualification data and hash(ID),
verifying the qualification data,
generating a qualification identifier, wherein the qualification identifier is generated by converting the hash into an identifier,
returning the qualification identifier, and;
generating a digital credential file which includes the qualification identifier and qualification data.
